(19) United States
(12) Patent Application Publication
(10) Pub. No.: US 2025/0211121 A1
(43) Pub. Date: Jun. 26, 2025

(54) SWITCHING CONVERTER WITH LOW NO LOAD POWER CONSUMPTION

(71) Applicant: Chengdu Monolithic Power Systems Co., Ltd., Chengdu (CN)

(72) Inventors: Hui Li, Zhejiang (CN); Feng Jin, Zhejiang (CN); Siran Wang, Zhejiang (CN)

(21) Appl. No.: 19/000,651

(22) Filed: Dec. 23, 2024

(30) Foreign Application Priority Data
Dec. 25, 2023 (CN) 202311806870.3

(51) Int. Cl. H02M 3/335; H02M 1/00; H02M 1/36

(52) U.S. Cl. CPC H02M 3/33507; H02M 1/0032; H02M 1/36

(57) ABSTRACT

A switching converter includes a voltage converting circuit, an output feedback circuit and a switch control circuit. The voltage converting circuit is configured to convert an input voltage into an output voltage. The output feedback circuit is coupled to receive the output voltage and configured to provide an output feedback signal. The switch control circuit is coupled to the output feedback circuit to receive the output feedback signal and configured to generate a switch control signal to control the voltage converting circuit. Where during a time period when a load is disconnected from the switching converter, in response to the output voltage decreasing to a first output threshold, the output feedback circuit is configured to be a cut off connection state.

### CROSS-REFERENCE TO RELATED APPLICATIONS

This application claims the benefit of CN application Ser. No. 20/231,1806870.3, filed on Dec. 25, 2023, and incorporated herein by reference.

### TECHNICAL FIELD OF THE INVENTION

The present invention generally relates to electronic circuits, and more particularly but not exclusively, to switching converters and associated control circuits.

### BACKGROUND OF THE INVENTION

With the increasing importance of energy efficiency and environmental protection and the quick development of switching power supply technology, customers expect more and more on the efficiency of switching power supply products. For example, more and more customers require switching power supply products with extremely low no load power consumption. In order to improve the no load efficiency or the light load efficiency, common switching power supplies use many technologies, such as pulse skipping mode, burst mode and so on, to reduce the switching loss under no load or light load condition. However, there is still certain power loss when these switching power supplies operate under no load or light load condition, which can not satisfy the extremely low no load power consumption requirement.

### SUMMARY OF THE INVENTION

An embodiment of the present invention discloses a control circuit for a switching converter with an output feedback circuit. The control circuit includes a first pin, a second pin, a third pin, a switch control circuit and a sleep mode determining circuit. The first pin is configured to be coupled to the output feedback circuit to receive an output feedback signal. The second pin is configured to provide a switch control signal to control the power operation of the switching converter. The third pin is configured to be coupled to an auxiliary winding of the switching converter to receive an auxiliary winding voltage signal indicative of a voltage across the auxiliary winding. The switch control circuit is coupled to the first pin to receive the output feedback signal and configured to generate the switch control signal based on the output feedback signal. The sleep mode determining circuit is coupled to the third pin to receive the auxiliary winding voltage signal and configured to determine whether to enter a sleep mode based on the auxiliary winding voltage signal.

An embodiment of the present invention discloses a switching converter with a voltage converting circuit, an output feedback circuit and a switch control circuit. The voltage converting circuit is configured to convert an input voltage into an output voltage. The output feedback circuit is coupled to receive the output voltage and configured to provide an output feedback signal. The switch control circuit is coupled to the output feedback circuit to receive the output feedback signal and configured to generate a switch control signal to control the voltage converting circuit. Where during a time period when a load is disconnected from the switching converter, in response to the output voltage decreasing to a first output threshold, the output feedback circuit is configured to be a cut off connection state.

An embodiment of the present invention discloses a control circuit for a switching converter with an output feedback circuit. The control circuit includes a first pin, a second pin, a primary turning-on control circuit, an isolation circuit, a logic circuit and a sleep mode determining circuit. The first pin is configured to be coupled to the output feedback circuit to receive an output feedback signal. The second pin is configured to provide a switch control signal to control the power operation of the switching converter. The primary turning-on control circuit is coupled to the first pin to receive the output feedback signal and configured to generate a primary turning-on signal based on the output feedback signal. The isolation circuit is configured to generate a sync signal pulse electrically isolated from the primary turning-on signal. The logic circuit is configured to generate the switch control signal based on the sync signal pulse. The sleep mode determining circuit is configured to determine whether to enter a sleep mode based on the switch control signal.

### BRIEF DESCRIPTION OF DRAWINGS

The present invention can be further understood with reference to the following detailed description and the appended drawings, wherein like elements are provided with like reference numerals.

FIG. 1 illustrates a block diagram of a switching converter 100 in accordance with an embodiment of the present invention.

FIG. 2 illustrates a circuit schematic of a switching converter 200A in accordance with another embodiment of the present invention.

FIG. 3 illustrates a circuit schematic of a control circuit 12B used in the switching converter 200A with an embodiment of the present invention.

FIG. 4 illustrates a working flowchart of the control circuit 12B and a PD controller 13A during a time period when a load is disconnected from the switching converter 200A in accordance with an embodiment of the present invention.

FIG. 5 illustrates a working waveform of the switching converter 200A in accordance with an embodiment of the present invention.

FIG. 6 illustrates a circuit schematic of a switching converter 200B in accordance with an embodiment of the present invention.

FIG. 7 illustrates a circuit schematic of a switching converter 200C in accordance with an embodiment of the present invention.

FIG. 8 illustrates a circuit schematic of a control circuit 12D used in the switching converter 200C in accordance with an embodiment of the present invention.

FIG. 9 illustrates a working flowchart of the control circuit 12D and a PD controller 13C during a time period when a load is disconnected from the switching converter 200C in accordance with an embodiment of the present invention.

FIG. 10 illustrates a working waveform of the switching converter 200C in accordance with an embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Reference to “one embodiment”, “an embodiment”, “an example” or “examples” means: certain features, structures, or characteristics are contained in at least one embodiment of the present invention. These “one embodiment”, “an embodiment”, “an example” and “examples” are not necessarily directed to the same embodiment or example. Furthermore, the features, structures, or characteristics may be combined in one or more embodiments or examples. In addition, it should be noted that the drawings are provided for illustration and are not necessarily to scale. And when an element is described as “connected” or “coupled” to another element, it can be directly connected or coupled to the other element, or there could exist one or more intermediate elements. In contrast, when an element is referred to as “directly connected” or “directly coupled” to another element, there is no intermediate element.

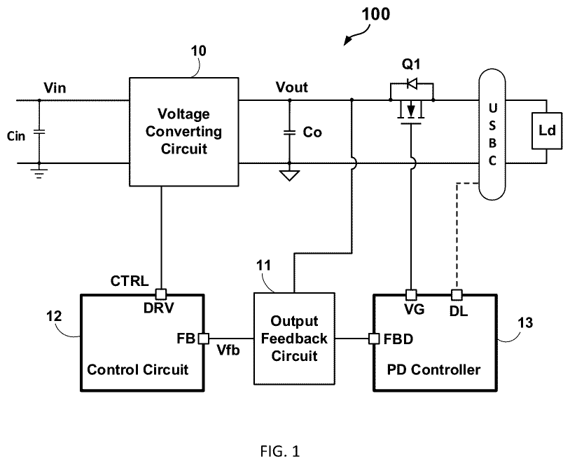

FIG. 1 illustrates a block diagram of a switching converter 100 in accordance with an embodiment of the present invention. In the example shown in FIG. 1, the switching converter 100 includes an input capacitor Cin, a voltage converting circuit 10, an output capacitor Co, an output feedback circuit 11 and a control circuit 12.

The voltage converting circuit 10 includes a power switch (not shown) and converts an input voltage Vin into an output voltage Vout to power a load Ld via the turning-on and the turning-off of the power switch. The output feedback circuit 11 is coupled to an output terminal of the voltage converting circuit 10 and generates an output feedback signal Vfb.

The control circuit 12 has a plurality of pins, including a feedback pin FB and a driving pin DRV. The feedback pin FB is coupled to the output feedback circuit 11 and the control circuit 12 receives the output feedback signal Vfb through the feedback pin FB. The driving pin DRV is coupled to the voltage converting circuit 10 and the control circuit 12 provides a switch control signal CTRL to control the voltage converting circuit 10 through the driving pin DRV.

In one embodiment, during the load connected to the switching converter 100, the output feedback circuit 11 is configured to be a normal connection state and the control circuit 12 is configured to operate in a normal work mode.

Those skilled in the art can understand that the normal connection state of the output feedback circuit 11 refers that the output feedback circuit 11 is coupled to the output terminal of the voltage converting circuit 10 normally and the generated output feedback signal Vfb can represent the output voltage Vout. Then the output voltage Vout can be regulated to an expected value based on the output feedback signal Vfb. The normal work mode of the control circuit 12 refers that the control circuit 12 generates the switch control signal CTRL based on the output feedback signal Vfb indicative of the output voltage Vout and regulates the output voltage Vout to the expected value. Meanwhile, function blocks of the control circuit 12, such as overload protection function and so on, are enabled.

In one embodiment, during the time period when the load is disconnected from the switching converter 100, the output feedback circuit 11 is configured to be a cut off connection state. In response to the cut off connection state of the output feedback circuit 11, the control circuit 12 is configured to enter a sleep mode.

Those skilled in the art can understand that the cut off connection state of the output feedback circuit 11 refers that the output feedback circuit 11 is open and there is substantially no current flowing through the output feedback circuit 11. The sleep mode of the control circuit 12 refers that the switch control signal CTRL keeps invalid (e.g., logic low), the power switch of the voltage converting circuit 10 keeps off and the switching converter 100 stops switching. Meanwhile, some function blocks of the control circuit 12, such as the overload protection function, are disabled. In one embodiment, the overload protection function is used to detect whether overload occurs and to turn off or restart the switching converter 100 when the overload is detected.

According to the embodiment of the present invention, during the time period when the load is disconnected from the switching converter 100, the output feedback circuit 11 is configured to be the cut off connection state and the control circuit 12 operates in the sleep mode. This can help reduce the power loss and then the switching converter 100 has extremely low no load power consumption.

Those skilled in the art can understand that during the time period when the load is disconnected from the switching converter 100, besides the cut off connection state, the output feedback circuit 11 can also be configured to be other states, such as the normal connection state and a short to ground state, which will be described in detail in the following embodiments. In one embodiment, the short to ground state of the output feedback circuit 11 refers that the output feedback circuit 11 is shorted and the current flowing through the output feedback circuit 11 reaches maximum.

Continue referring to FIG. 1, the switching converter 100 further includes a switch Q1, a USB port USBC and a PD (power delivery) controller 13.

As shown in FIG. 1, the PD controller 13 has a plurality of pins, including a pin VG coupled to the switch Q1 and a pin FBD coupled to the output feedback circuit 11. The PD controller 13 is configured to detect whether the load is disconnected from the switching converter 100. For example, the PD controller 13 can detect whether an electronic device is disconnected from the USB port USBC through a pin DL. In response to the load being disconnected from the switching converter 100 or being connected to the switching converter 100, the PD controller 13 is configured to configure the state of the output feedback circuit 11 through the pin FBD.

As shown in FIG. 1, the PD controller 13 is further configured to control the switch Q1 through the pin VG based on the power requirement of the USB port USBC, thereby configuring the voltage converting circuit 10 to power the USB port USBC. In one embodiment, in response to the load being disconnected from the USB port USBC, the switch Q1 is configured to be turned off to disconnect the USB port USBC from the voltage converting circuit 10 and the output capacitor Co, thereby avoiding the output voltage Vout reduces too much when the load is reconnected to the USB port USBC.

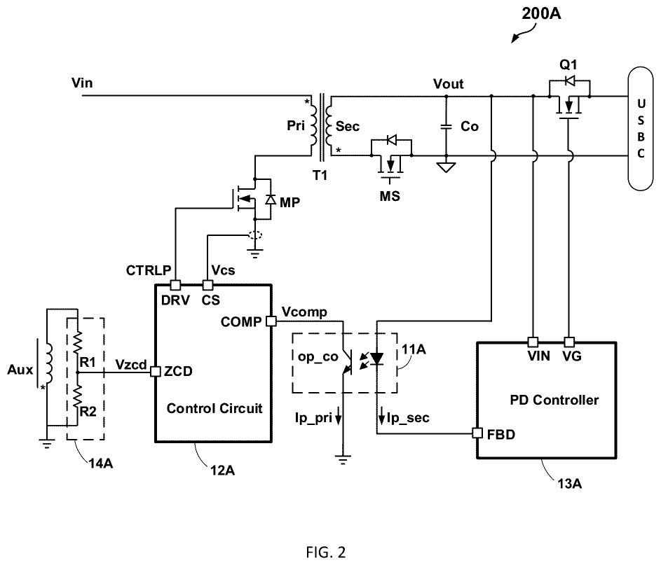

FIG. 2 illustrates a circuit schematic of a switching converter 200A in accordance with another embodiment of the present invention. As shown in FIG. 2, the switching converter 200A includes a transformer T1, a primary switch MP, a secondary switch MS, an output capacitor Co, an output feedback circuit 11A, a control circuit 12A and a PD controller 13A. The transformer T1 has a primary winding Pri and a secondary winding Sec, where both the primary winding Pri and the secondary winding Sec have a first terminal and a second terminal. The first terminal of the primary winding Pri is coupled to receive an input voltage Vin. The primary switch MP is coupled between the second terminal of the primary winding Pri and a primary reference ground. The first terminal of the secondary winding Sec is coupled to provide an output voltage Vout. The secondary switch MS is coupled between the second terminal of the secondary winding Sec and a secondary reference ground. The voltage across the output capacitor Co is the output voltage Vout. Those skilled in art can understand that the secondary switch MS can also be coupled between the first terminal of the secondary winding Sec and the output capacitor Co.

In the example shown in FIG. 2, the output feedback circuit 11A includes an optocoupler op_co. The optocoupler op_co has a photo sensitive device at the primary side and a light emitting device at the secondary side, where a first terminal of the light emitting device is coupled to the output voltage Vout.

The control circuit 12A has a plurality of pins, including a feedback pin COMP, a current sensing pin CS, a zero-crossing detecting pin ZCD and a driving pin DRV.

The feedback pin COMP is coupled to the photo sensitive device of the optocoupler op_co to receive an output feedback signal Vcomp. The current sensing pin CS is coupled to the primary switch MP to receive a primary current signal Vcs indicative of a current flowing through the primary switch MP. The zero-crossing detecting pin ZCD is coupled to an auxiliary winding Aux of the transformer T1 to detect a voltage across the auxiliary winding Aux. In the example shown in FIG. 2, the zero-crossing detecting pin ZCD is coupled to a voltage detecting circuit 14A to receive an auxiliary winding voltage signal Vzcd indicative of the voltage across the auxiliary winding Aux, where the voltage detecting circuit 14A includes resistors R1 and R2. The control circuit 12A is configured to provide a switch control signal CTRLP through the driving pin DRV to the primary switch MP to control the power operation of the switching converter 200A.

The PD controller 13A at the secondary side has a plurality of pins, including a pin FBD, a pin VIN and a pin VG. The pin FBD is coupled to the second terminal of the light emitting device of the optocoupler op_co. The PD controller 13A is configured to detect the output voltage Vout through the Pin VIN and to configure the state of the output feedback circuit 11A through the pin FBD.

In one embodiment, during the load connected to the switching converter 200A, the PD controller 13A configures the output feedback circuit 11A to be the normal connection state. At this time, the output feedback signal Vcomp has a first state (e.g., the output feedback signal Vcomp can represent the output voltage Vout). In response to the first state of the output feedback signal Vcomp, the control circuit 12A operates in the normal work mode.

In one embodiment, during the time period when the load is disconnected from the switching converter 200A, the output feedback circuit 11A can be configured to be the cut off connection state or the short to ground state. In response to the cut off connection state or the short to ground state of the output feedback circuit 11A, the control circuit 12A is configured to enter the sleep mode or to exit the sleep mode. In one embodiment, the control circuit 12A determines whether to enter the sleep mode based on the auxiliary winding voltage signal Vzcd and determines whether to exit the sleep mode based on the output feedback signal Vcomp.

In a further embodiment, during the time period when the load is disconnected from the switching converter 200A, in response to the output voltage Vout decreasing to a first output threshold Vo1, the PD controller 13A configures the output feedback circuit 11A to be the cut off connection state (e.g., the PD controller 13A disconnects the second terminal of the light emitting device from the secondary reference ground through the pin FBD and a current Ip_dec flowing through the light emitting device is substantially zero). At this time, the output feedback signal Vcomp has a second state (e.g., the output feedback signal Vcomp reaches maximum). In response to the second state of the output feedback signal Vcomp, the output voltage Vout increases sharply and the auxiliary winding voltage signal Vzcd also increases sharply. In response to the sharp increase of the auxiliary winding voltage signal Vzcd, the control circuit 12A enters the sleep mode.

In another further embodiment, during the sleep mode, in response to the output voltage Vout decreasing to a second output threshold Vo2, the PD controller 13A configures the output feedback circuit 11A to be the short to ground state (e.g., the PD controller 13A shorts the pin FBD to the secondary reference ground and the current Ip_dec flowing through the light emitting device reaches maximum). At this time, the output feedback signal Vcomp has a third state (e.g., the output feedback signal Vcomp reaches minimum). In response to the output feedback signal Vcomp decreasing to a feedback threshold Vcompth, the control circuit 12A exits the sleep mode. In one embodiment, the second output threshold Vo2 is higher than the first output threshold Vo1.

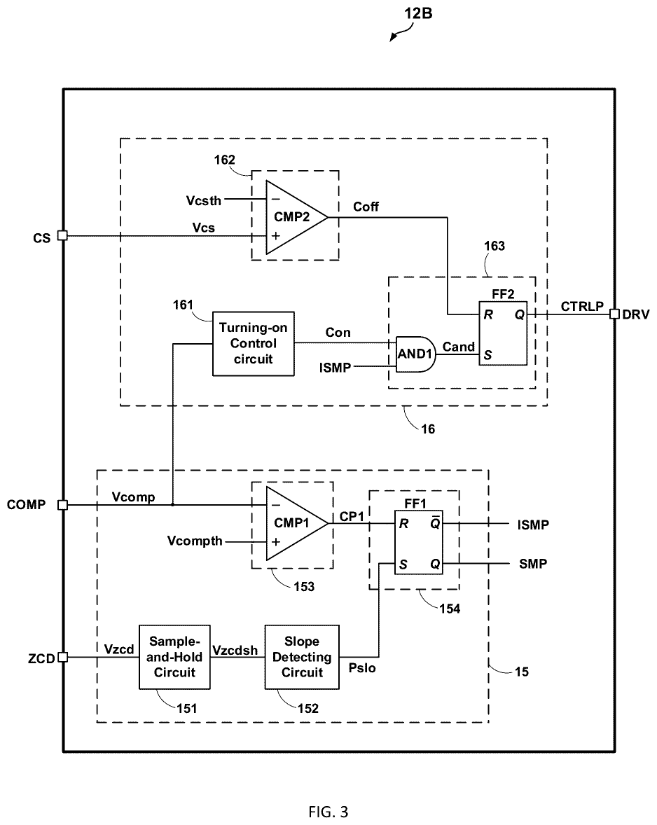

FIG. 3 illustrates a circuit schematic of a control circuit 12B used in the switching converter 200A with an embodiment of the present invention. As shown in FIG. 3, the control circuit 12B includes a sleep mode determining circuit 15 and a switch control circuit 16.

The sleep mode determining circuit 15 includes a sample-and-hold circuit 151, a slope detecting circuit 152, a first comparing circuit 153 and a first logic circuit 154.

The sample-and-hold circuit 151 is coupled to the zero-crossing detecting pin ZCD to receive the auxiliary winding voltage signal Vzcd and generates a sample-and-hold signal Vzcdsh based on the auxiliary winding voltage signal Vzcd.

The slope detecting circuit 152 detects the rising slope of the sample-and-hold signal Vzcdsh and generates a slope detecting signal Pslo based on the detection result. In one embodiment, the slope detecting circuit 152 detects whether the sample-and-hold signal Vzcdsh increases from a low value Vthl to a high value Vthh within a detect time threshold tth. If so, the slope detecting signal Pslo is valid (e.g., logic high). In another embodiment, the slope detecting circuit 152 compares the rising slope of the sample-and-hold signal Vzcdsh with a slope threshold. In response to the rising slope of the sample-and-hold signal Vzcdsh higher than the slope threshold, the slope detecting signal Pslo is valid. Those skilled in the art can understand that if the magnetic coupling between the auxiliary winding Aux and the secondary winding Sec of the switching converter 200A is changed, when the output voltage Vout increases sharply, the auxiliary winding voltage signal Vzcd decreases sharply. On this condition, the slope detecting circuit 152 can detect the falling slope of the sample-and-hold signal Vzcdsh to determine whether there is a sharp decrease in the auxiliary winding voltage signal Vzcd and generate the slope detecting signal Pslo based on the detection result.

The first comparing circuit 153 is coupled to the feedback pin COMP to receive the output feedback signal Vcomp and generates a first comparing signal CP1 by comparing the output feedback signal Vcomp with the feedback threshold Vcompth. In one embodiment, in response to the output feedback signal Vcomp decreasing to the feedback threshold Vcompth, the first comparing signal CP1 is valid (e.g., logic high). In one embodiment, the first comparing circuit 153 includes a first comparator CMP1.

The first logic circuit 154 receives the slope detecting signal Pslo and the first comparing signal CP1 and generates a sleep mode signal SMP based on the slope detecting signal Pslo and the first comparing signal CP1. In one embodiment, the first logic circuit 154 includes a first RS flip-flop FF1 having a set terminal S, a reset terminal R, an output terminal Q and an inverting output terminal Q̅. Where the set terminal S receives the slope detecting signal Pslo, the reset terminal R receives the first comparing signal CP1, the output terminal Q provides the sleep mode signal SMP and the inverting output terminal Q̅ provides an inverting sleep mode signal ISMP. In one embodiment, in response to the sleep mode signal SMP valid (e.g., logic high), the control circuit 12B enters the sleep mode, the overload protection function is disabled.

The switch control circuit 16 includes a turning-on control circuit 161, a turning-off control circuit 162 and a second logic circuit 163.

The turning-on control circuit 161 is coupled to the feedback pin COMP to receive the output feedback signal Vcomp and generates a turning-on control signal Con to control the turning-on of the primary switch MP based on the output feedback signal Vcomp. In one embodiment, when the output feedback signal Vcomp increases, the frequency of the turning-on control signal Con increases; when the output feedback signal Vcomp decreases, the frequency of the turning-on control signal Con decreases.

The turning-off control circuit 162 is coupled to the current sensing pin CS to receive the primary current signal Vcs and generates a turning-off control signal Coff by comparing the primary current signal Vcs with a current threshold Vcsth. In one embodiment, in response to the primary current signal Vcs increasing to the current threshold Vcsth, the turning-off control signal Coff is valid (e.g., logic high). In one embodiment, the turning-off control circuit 162 includes a second comparator CMP2.

The second logic circuit 163 receives the turning-on control signal Con, the inverting sleep mode signal ISMP and the turning-off control signal Coff and generates the switch control signal CTRLP based on the turning-on control signal Con, the inverting sleep mode signal ISMP and the turning-off control signal Coff. In one embodiment, the second logic circuit 163 includes an AND gate AND1 and a second RS flip-flop FF2. The AND gate AND1 performs a logic AND operation on the inverting sleep mode signal ISMP and the turning-on control signal Con and generates an and signal Cand. The second RS flip-flop FF2 has a set terminal S, a reset terminal R and an output terminal Q, where the set terminal S receives the and signal Cand, the reset terminal R receives the turning-off control signal Coff and the output terminal Q provides the switch control signal CTRLP. In one embodiment, in response to the sleep mode signal SMP valid (e.g., logic high), the switch control signal CTRLP is logic low.

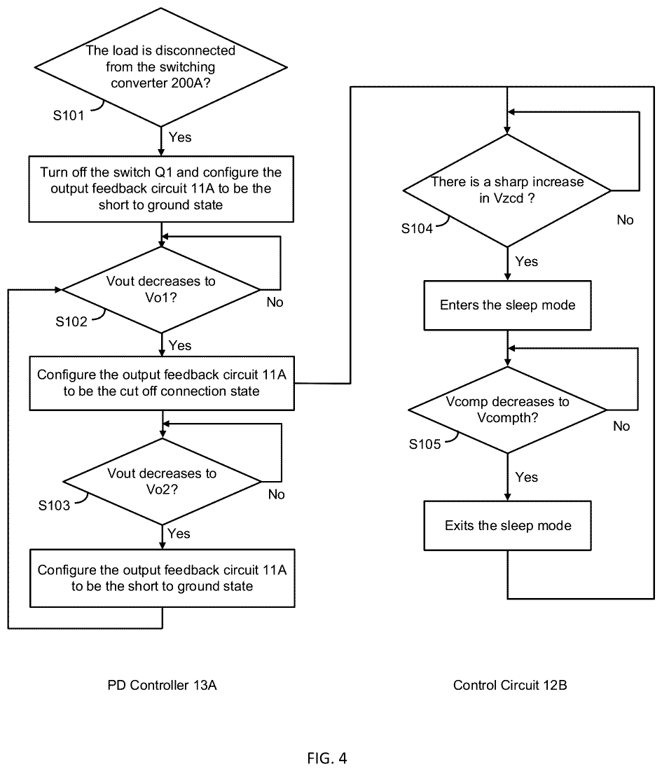

FIG. 4 illustrates a working flowchart of the control circuit 12B and a PD controller 13A during the time period when the load is disconnected from the switching converter 200A in accordance with an embodiment of the present invention. The working flowchart includes steps S101˜S105.

The PD controller 13A performs the steps S101˜S103. At step S101, it is detected whether the load is disconnected from the switching converter 200A. If yes, the switch Q1 is configured to be turned off and the output feedback circuit 11A is configured to be the short to ground state.

At step S102, it is detected whether the output voltage Vout decreases to the first output threshold Vo1. If yes, the output feedback circuit 11A is configured to be the cut off connection state.

At step S103, it is detected whether the output voltage Vout decreases to the second output threshold Vo2. If yes, the output feedback circuit 11A is configured to be the short to ground state.

The control circuit 12B performs the steps S104˜S105. At step S104, it is detected whether there is a sharp increase in the auxiliary winding voltage signal Vzcd. If yes, the control circuit 12B enters the sleep mode. In one embodiment, the control circuit 12B detects the sharp increase of the auxiliary winding voltage signal Vzcd by detecting whether the auxiliary winding voltage signal Vzcd increases from a low value to a high value within a detect time threshold. In another embodiment, the control circuit 12B detects the sharp increase of the auxiliary winding voltage signal Vzcd by comparing a slope of the auxiliary winding voltage signal Vzcd with a slope threshold.

At step S105, it is detected whether the output feedback signal Vcomp decreases to the feedback threshold Vcompth. If yes, the control circuit 12B exits the sleep mode.

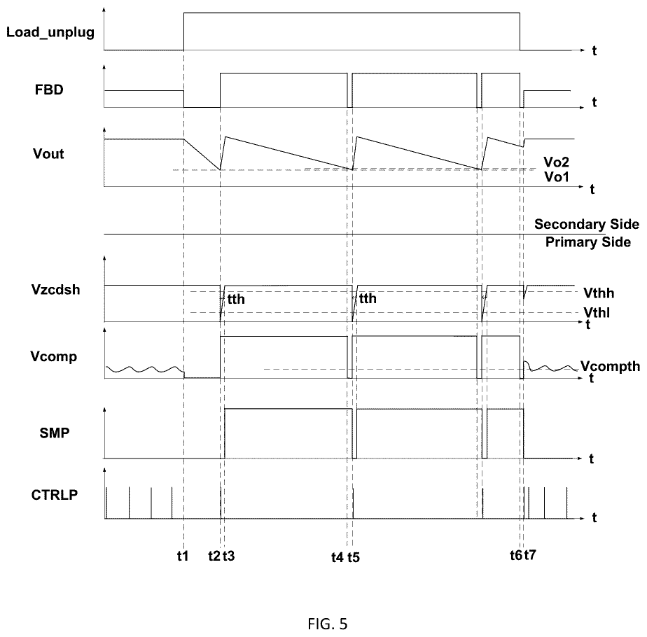

FIG. 5 illustrates a working waveform of the switching converter 200A in accordance with an embodiment of the present invention. The working principle of the switching converter 200A will be set forth referring to FIG. 2˜FIG. 5.

As shown in FIG. 5, before time t1, a load indicating signal Load_unplug is logic low, indicating that the load is connected to the switching converter 200A. The output feedback circuit 11A is configured to be the normal connection state, the output feedback signal Vcomp has a first state, the control circuit 12B operates in the normal work mode and the output voltage Vout keeps at the expected value.

At time t1, the load indicating signal Load_unplug changes from logic low to logic high, indicating that the load is disconnected from the switching converter 200A. The output feedback circuit 11A is configured to be the short to ground state and the output feedback signal Vcomp has the second state (e.g., the output feedback signal Vcomp reaches minimum). The switch control signal CTRLP keeps logic low and the output voltage Vout decreases.

At time t2, the output voltage Vout decreases to the first output threshold Vo1, the output feedback circuit 11A is configured to be the cut off connection state, the output feedback signal Vcomp has the third state (e.g., the output feedback signal Vcomp reaches maximum), the switch control signal CTRLP switches between logic low and logic high, the output voltage Vout increases sharply and the auxiliary winding voltage signal Vzcd also increases sharply.

At time t3, in response to the sharp increase of the auxiliary winding voltage signal Vzcd (e.g., the sample-and-hold signal Vzcdsh increases from the low value Vthl to the high value Vthh within the detect time threshold tth), the sleep mode signal SMP changes from logic low to logic high, the control circuit 12B enters the sleep mode. The switch control signal CTRLP keeps logic low and the output voltage Vout decreases.

At time t4, the output voltage Vout decreases to the second output threshold Vo2, the output feedback circuit 11A is configured to be the short to ground state, the output feedback signal Vcomp has the second state (e.g., the output feedback signal Vcomp reaches minimum). In response to the output feedback signal Vcomp decreasing to the feedback threshold Vcompth, the sleep mode signal SMP changes from logic high to logic low, the control circuit 12B exits the sleep mode. In the example shown in FIG. 5, in response to the time period when the output feedback signal Vcomp is lower than the feedback threshold Vcompth becoming longer than a feedback time threshold, the sleep mode signal SMP changes from logic high to logic low.

At time t5, the output voltage Vout decreases the first output threshold Vo1 again, the output feedback circuit 11A is configured to be the cut off connection state. The output feedback signal Vcomp has the third state (e.g., the output feedback signal Vcomp reaches maximum), the switch control signal CTRLP switches between logic low and logic high, the output voltage Vout increases sharply and the auxiliary winding voltage signal Vzcd also increases sharply. Then in response to the sharp increase of the auxiliary winding voltage signal Vzcd, the sleep mode signal SMP changes from logic low to logic high and the control circuit 12B enters the sleep mode again.

At time t6, the load indicating signal Load_unplug changes from logic high to logic low, indicating that the load is reconnected to the switching converter 200A, the output feedback circuit 11A is configured to be the short to ground state, the output feedback signal Vcomp has the second state (e.g., the output feedback signal Vcomp reaches minimum). In response to the output feedback signal Vcomp decreasing to the feedback threshold Vcompth, the sleep mode signal SMP changes from logic high to logic low and the control circuit 12B exits the sleep mode.

At time t7, the load indicating signal Load_unplug is logic low, indicating that the load is connected to the switching converter 200A normally, the output feedback circuit 11A is configured to be the normal connection state and the control circuit 12B operates in the normal work mode.

In the above embodiments, during the time period when the load is disconnected from the switching converter 200A, most of the time, the output feedback circuit 11A is in the cut off connection state and the control circuit 12B is in the sleep mode. The power loss of the output feedback circuit 11A and the control circuit 12B decreases greatly and the switching converter 200A has extremely low no load power consumption.

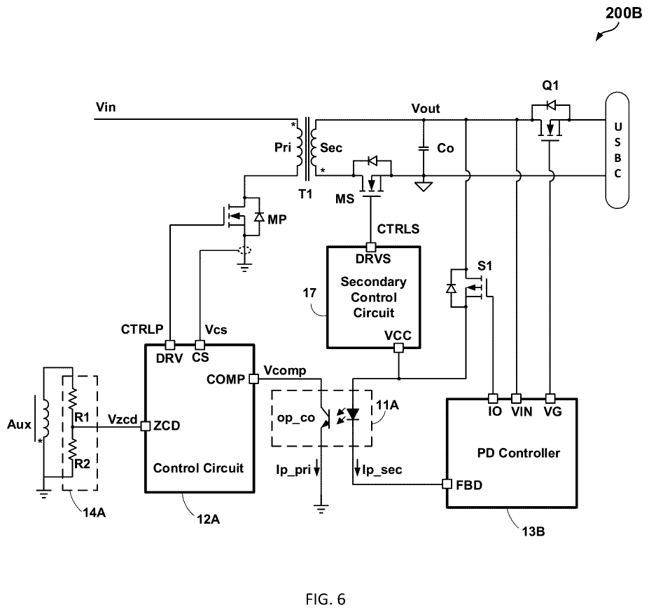

FIG. 6 illustrates a circuit schematic of a switching converter 200B in accordance with an embodiment of the present invention. Different from the switching converter 200A shown in FIG. 2, the switching converter 200B further includes a secondary control circuit 17 for controlling the secondary switch MS. The secondary control circuit 17 includes a driving pin DRVS and a power supply pin VCC. The secondary control circuit 17 provides a secondary control signal CTRLS to the secondary switch MS though the driving pin DRVS. The power supply pin VCC is coupled to the output voltage Vout and the secondary control circuit 17 is powered by the output voltage Vout.

In one embodiment, when the output feedback circuit 11A is configured to be the cut off connection state, the power supply pin VCC is configured to be disconnected from the output voltage Vout to further reduce the power loss. In the example shown in FIG. 6, the power supply pin VCC is coupled to the output voltage Vout through a switch S1 and is also coupled to the output feedback circuit 11A. The PD controller 13B can configure the output feedback circuit 11A to be the cut off connection state and disconnect the power supply pin VCC from the output voltage Vout by turning off the switch S1 through a pin IO.

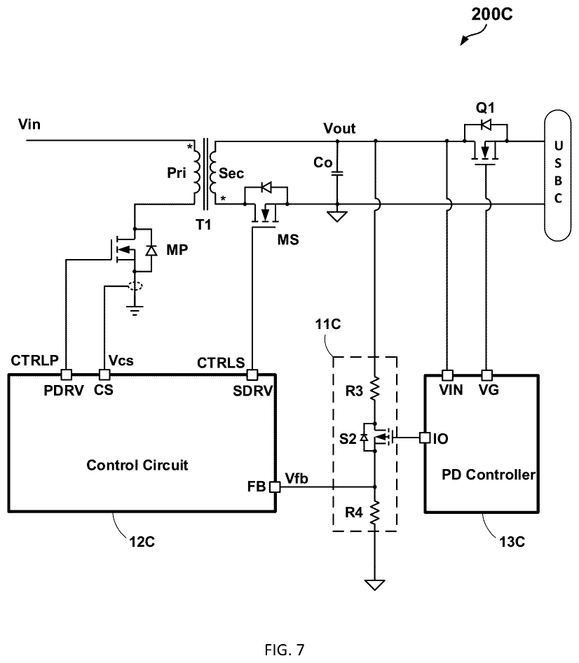

FIG. 7 illustrates a circuit schematic of a switching converter 200C in accordance with an embodiment of the present invention. The switching converter 200C includes a transformer T1, a primary switch MP, a secondary switch MS, an output capacitor Co, an output feedback circuit 11C, a control circuit 12C and a PD controller 13C connected as shown in FIG. 7.

The output feedback circuit 11C is coupled to an output voltage Vout and provides an output feedback signal Vfb. In the example shown in FIG. 7, the output feedback circuit 11C includes resistors R3 and R4.

The control circuit 12C integrates functions such as isolation control, primary control and secondary control into a single integrated circuit. The control circuit 12C has a plurality of pins, including a feedback pin FB, a secondary driving pin SDRV, a current sensing pin CS and a primary driving pin PDRV. The feedback pin FB is coupled to the output feedback circuit 11C to receive the output feedback signal Vfb. The current sensing pin CS is coupled to the primary switch MP to receive a primary current signal Vcs indicative of a current flowing through the primary switch MP. The primary driving pin PDRV and the secondary driving pin SDRV provides a switch control signal CTRLP and a secondary control signal CTRLS to the primary switch MP and the secondary switch MS respectively, thereby controlling the power operation of the switching converter 200C.

The PD controller 13C at secondary side includes a pin IO, a pin VIN and a pin VG. The pin IO is coupled to the output feedback circuit 11C and the PD controller 13C can configure the state of the output feedback circuit 11C through the pin IO. The pin VIN is coupled to the output voltage Vout and the PD controller 13C can detect the output voltage Vout through the pin VIN. The pin VG is coupled to a switch Q1 and the PD controller 13 can control the switch Q1 through the pin VG based on the power requirement of a USB port USBC.

In the example shown in FIG. 7, the output feedback circuit 11C further includes a switch S2. The PD controller 13C can configure the output feedback circuit 11C to be the normal connection state/the cut off connection state by turning on/turning off the switch S2 through the pin IO.

In one embodiment, during a load connected to the switching converter 200C, the PD controller 13C configures the output feedback circuit 11C to be the normal connection state and the output feedback signal Vfb has a first state (e.g., the output feedback signal Vfb can represent the output voltage Vout). The control circuit 12C operates in the normal work mode.

In one embodiment, during the time period when the load is disconnected from the switching converter 200C, the output feedback circuit 11C is configured to be the cut off connection state or the normal connection state. In response to the cut off connection state or the normal connection state of the output feedback circuit 11C, the control circuit 12C is configured to enter the sleep mode or exit the sleep mode.

In a further embodiment, during the time period when the load is disconnected from the switching converter 200C, in response to the output voltage Vout increases to a third output threshold Vo3, the PD controller 13C configures the output feedback circuit 11C to be the cut off connection state. The output feedback signal Vfb has a second state (e.g., the output feedback signal Vfb keeps zero). The switch control signal CTRLP keeps logic low. In response to the duration of the switch control signal CTRLP keeping logic low (i.e., the switching converter 200C stops switching) reaching a time threshold Tdet, the control circuit 12C enters the sleep mode.

In another further embodiment, during the time period when the load is disconnected from the switching converter 200C, in response to the output voltage Vout decreases to a fourth output threshold Vo4, the PD controller 13C configures the output feedback circuit 11C to be the normal connection state. The output feedback signal Vfb has the first state and the switch control signal CTRLP switches between logic low and logic high. The control circuit 12C exits the sleep mode.

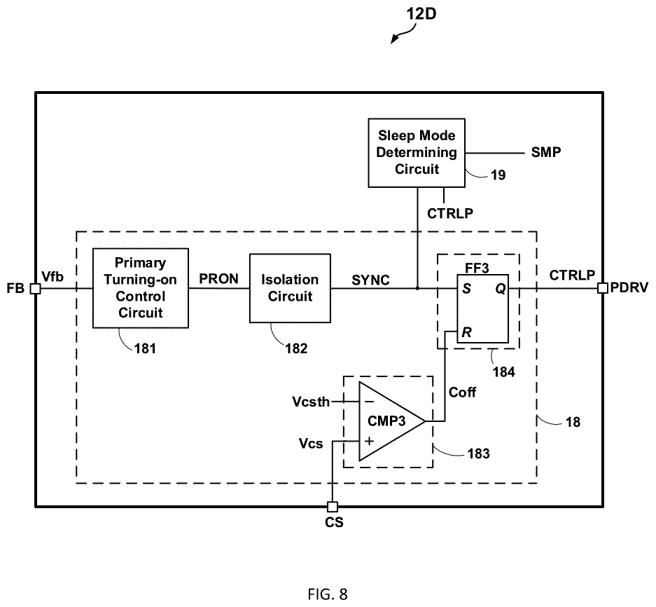

FIG. 8 illustrates a circuit schematic of a control circuit 12D used in the switching converter 200C in accordance with an embodiment of the present invention. As shown in FIG. 8, the control circuit 12D includes a switch control circuit 18 and a sleep mode determining circuit 19.

The switch control circuit 18 includes a primary turning-on control circuit 181, an isolation circuit 182, a turning-off control circuit 183 and a logic circuit 184.

The primary turning-on control circuit 181 is coupled to the feedback pin FB to receive the output feedback signal Vfb and generates a primary turning-on signal PRON based on the output feedback signal Vfb. In one embodiment, the output feedback signal Vfb decreases, the frequency of the primary turning-on signal PRON decreases.

The isolation circuit 182 receives the primary turning-on signal PRON and generates a sync signal pulse SYNC electrically from the primary turning-on signal PRON to control the turning-on of the primary switch MP.

The turning-off control circuit 183 is coupled to the current sensing pin CS to receive the primary current signal Vcs and generates a turning-off control signal Coff to control the turning-off of the primary switch MP by comparing the primary current signal Vcs with a current threshold Vcsth. In one embodiment, in response to the primary current signal Vcs increasing to the current threshold Vcsth, the turning-off control signal Coff is valid (e.g., logic high). In one embodiment, the turning-off control circuit 162 includes a third comparator CMP3.

The logic circuit 184 receives the sync signal pulse SYNC and the turning-off control signal Coff and generates the switch control signal CTRLP based on the sync signal pulse SYNC and the turning-off control signal Coff. In one embodiment, the logic circuit 184 includes a third RS flip-flop FF3 having a set terminal S, a reset terminal R and an output terminal Q, where the set terminal S receives the sync signal pulse SYNC, the reset terminal R receives the turning-off control signal Coff and the output terminal Q provides the switch control signal CTRLP.

The sleep mode determining circuit 19 generates the sleep mode signal SMP based on the sync signal pulse SYNC and the switch control signal CTRLP. In one embodiment, in response to the sync signal pulse SYNC appearing, the sleep mode signal SMP is invalid and the control circuit 12D exits the sleep mode. In one embodiment, in response to the duration of the switch control signal CTRLP keeping logic low reaching the time threshold Tdet, the sleep mode signal SMP is valid and the control circuit 12D enters the sleep mode. In one embodiment, when the sleep mode signal SMP is valid, the overload protection function is disabled.

Those skilled in the art can understand that the sleep mode determining circuit 19 can also generate the sleep mode signal SMP based on a single signal of the sync signal pulse SYNC and the switch control signal CTRLP. For example, in response to the switch control signal CTRLP switching between logic low and logic high, the sleep mode signal SMP is invalid. In response to the logic low duration of the switch control signal CTRLP reaching the time threshold Tdet, the sleep mode signal SMP is valid.

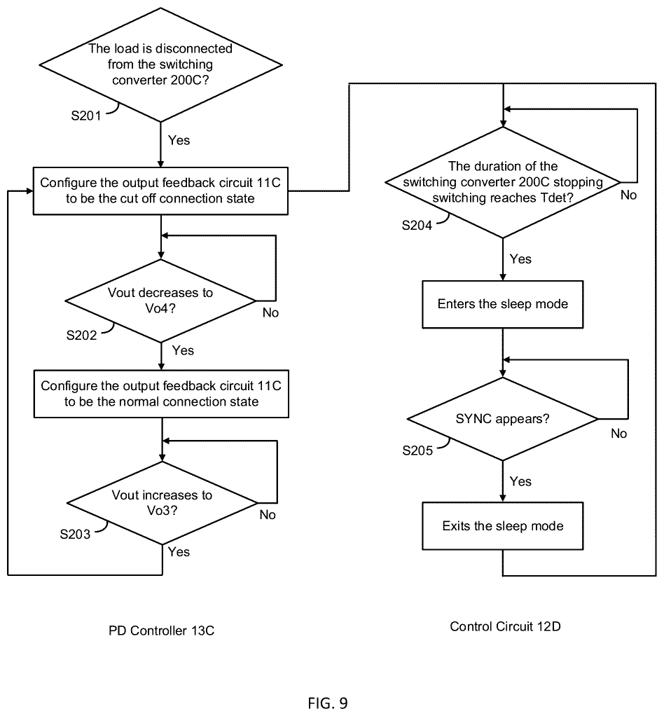

FIG. 9 illustrates a working flowchart of the control circuit 12D and a PD controller 13C during a time period when a load is disconnected from the switching converter 200C in accordance with an embodiment of the present invention. The working flowchart includes steps S201˜S205.

The PD controller 13C performs the steps S201˜S203. At step S201, it is detected whether the load is disconnected from the switching converter 200C. If yes, the output feedback circuit 11C is configured to be the cut off connection state.

At step S202, it is detected whether the output voltage Vout decreases to the fourth output threshold Vo4. If yes, the output feedback circuit 11C is configured to be the normal connection state.

At step S203, it is detected whether the output voltage Vout increases to the third output threshold Vo3. If yes, the output feedback circuit 11C is configured to be the cut off connection state.

The control circuit 12D performs the steps S204˜S205. At step S204, it is determined whether the duration of the switching converter 200C stopping switching reaches the time threshold Tdet. If yes, the control circuit 12D enters the sleep mode.

At step S205, it is detected whether the sync signal pulse SYNC appears. If yes, the control circuit 12D exits the sleep mode.

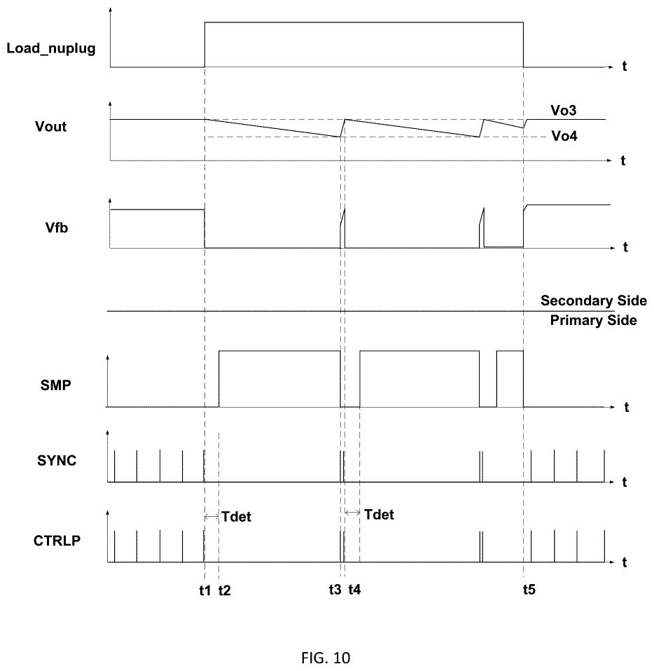

FIG. 10 illustrates a working waveform of the switching converter 200C in accordance with an embodiment of the present invention. The working principle of the switching converter 200C will be set forth referring to the FIG. 7˜FIG. 10.

As shown in FIG. 10, before time t1, the load indicating signal Load_unplug is logic low, indicating that the load is connected to the switching converter 200C normally. The output feedback circuit 11C is configured to be the normal connection state and the control circuit 12D operates in the normal work mode.

At time t1, the load indicating signal Load_unplug changes from logic low to logic high, indicating that the load is disconnected from the switching converter 200C. The output feedback circuit 11C is configured to be the cut off connection state, the output feedback signal Vfb has the second state (e.g., the output feedback signal Vfb keeps zero). The switch control signal CTRLP keeps logic low and the output voltage Vout decreases.

At time t2, the duration of the switching converter 200C stopping switching reaches the time threshold Tdet, the sleep mode signal SMP changes from logic low to logic high and the control circuit 12D enters the sleep mode.

At time t3, the output voltage Vout decreases to the fourth output threshold Vo4, the output feedback circuit 11C is configured to be the normal connection state and the output feedback signal Vfb has the first state. The sync signal pulse SYNC appears, the sleep mode signal SMP changes from logic high to logic low and the control circuit 12D exits the sleep mode. The switch control signal CTRLP switches between logic low and logic high and the output voltage Vout increases.

At time t4, the output voltage Vout increases to the third output threshold Vo3, the output feedback circuit 11C is configured to be the cut off connection state and the output feedback signal Vfb has the second state. The switch control signal CTRLP keeps logic low and the output voltage Vout decreases. After the duration of the switching converter 200C stopping switching reaches the time threshold Tdet, the sleep mode signal SMP changes from logic low to logic high and the control circuit 12D enters the sleep mode again.

At time t5, the load indicating signal Load_unplug changes from logic high to logic low, indicating that the load is reconnected to the switching converter 200C. The output feedback circuit 11C is configured to be the normal connection state and the control circuit 12D operates in the normal work mode.

According to the embodiments of the present invention, during the time period when the load is disconnected from the switching converter, the output feedback circuit is configured to be the cut off connection state and the control circuit operates in the sleep mode, thus the power loss is reduced and the switching converter has extremely low no load power consumption.

In the examples shown above, the PD controller is used to detect the load, to detect the output voltage and to configure the state of the output feedback circuit. However, those skilled in the art can understand that the PD controller is exemplary illustration, other suitable circuits are also applicable here, as long as these circuits can detect whether the load is disconnected from the switching converter, detect the output voltage and configure the state of the output feedback circuit.

Those skilled in the art can understand that the logic high/logic low of control signal is related to the type of the power switch. The logic high/logic low of the control signals shown in the above embodiments are used for illustrative purposes, not used for limiting the present invention.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Obviously, many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit for a switching converter with an output feedback circuit, the control circuit comprising:
a first pin configured to be coupled to the output feedback circuit to receive an output feedback signal;
a second pin configured to provide a switch control signal to control the power operation of the switching converter;
a third pin configured to be coupled to an auxiliary winding of the switching converter to receive an auxiliary winding voltage signal indicative of a voltage across the auxiliary winding;
a switch control circuit coupled to the first pin to receive the output feedback signal and configured to generate the switch control signal based on the output feedback signal; and
a sleep mode determining circuit coupled to the third pin to receive the auxiliary winding voltage signal and configured to determine whether to enter a sleep mode based on the auxiliary winding voltage signal.

2. The control circuit of claim 1, wherein the sleep mode determining circuit is configured to determine whether to enter the sleep mode based on a slope of the auxiliary winding voltage signal.

3. The control circuit of claim 2, wherein the sleep mode determining circuit comprises:
a sample-and-hold circuit configured to generate a sample-and-hold signal based on the auxiliary winding voltage signal; and
a slope detecting circuit configured to detect whether the sample-and-hold signal increases from a low value to a high value within a detect time threshold.

4. The control circuit of claim 1, wherein the sleep mode determining circuit is further coupled to the first pin to receive the output feedback signal and configured to determine whether to exit the sleep mode based on the output feedback signal.

5. The control circuit of claim 4, wherein the sleep mode determining circuit comprises:
a comparing circuit configured to compare the output feedback signal with a feedback threshold to determine whether to exit the sleep mode.

6. The control circuit of claim 1, wherein during a time period when a load is disconnected from the switching converter, in response to an output voltage of the switching converter decreasing to a first output threshold, the output feedback circuit is configured to be a cut off connection state.

7. The control circuit of claim 6, wherein during the sleep mode, in response to the output voltage decreasing to a second output threshold, the output feedback circuit is configured to be a short to ground state, wherein the second output threshold is higher than the first output threshold.

8. The control circuit of claim 6, wherein the switching converter further comprises:
a secondary control circuit, wherein the secondary control circuit comprises a fourth pin configured to be coupled to the output voltage, wherein when the output feedback circuit is configured to be the cut off connection state, the fourth pin is configured to be disconnected from the output voltage.

9. The control circuit of claim 1, wherein when the control circuit enters the sleep mode, an overload protection function is disabled.

10. A switching converter comprising:
a voltage converting circuit configured to convert an input voltage into an output voltage;
an output feedback circuit coupled to receive the output voltage and configured to provide an output feedback signal; and
a switch control circuit coupled to the output feedback circuit to receive the output feedback signal and configured to generate a switch control signal to control the voltage converting circuit; wherein
during a time period when a load is disconnected from the switching converter, in response to the output voltage decreasing to a first output threshold, the output feedback circuit is configured to be a cut off connection state.

11. The switching converter of claim 10, further comprising:
a sleep mode determining circuit coupled to an auxiliary winding of the switching converter to receive an auxiliary winding voltage signal indicative of a voltage across the auxiliary winding and configured to determine whether to enter a sleep mode based on a slope of the auxiliary winding voltage signal.

12. The switching converter of claim 11, wherein the sleep mode determining circuit is further coupled to the output feedback circuit to receive the output feedback signal and configured to determine whether to exit the sleep mode based on the output feedback signal.

13. The switching converter of claim 11, wherein during the sleep mode, in response to the output voltage decreasing to a second output threshold, the output feedback circuit is configured to be a short to ground state, wherein the second output threshold is higher than the first output threshold.

14. The switching converter of claim 10, further comprising:
a secondary control circuit coupled to the output voltage to be powered by the output voltage, wherein when the output feedback circuit is configured to be the cut off connection state, the secondary control circuit is configured to be disconnected from the output voltage.

15. The switching converter of claim 10, further comprising:
a power delivery controller configured to detect whether the load is disconnected from the switching converter and coupled to the output feedback circuit to configure the state of the output feedback circuit.

16. A control circuit for a switching converter with an output feedback circuit, the control circuit comprising:
a first pin configured to be coupled to the output feedback circuit to receive an output feedback signal;
a second pin configured to provide a switch control signal to control the power operation of the switching converter;
a primary turning-on control circuit coupled to the first pin to receive the output feedback signal and configured to generate a primary turning-on signal based on the output feedback signal;
an isolation circuit configured to generate a sync signal pulse electrically isolated from the primary turning-on signal;
a logic circuit configured to generate the switch control signal based on the sync signal pulse; and
a sleep mode determining circuit configured to determine whether to enter a sleep mode based on the switch control signal.

17. The control circuit of claim 16, wherein in response to a duration of the switching converter stopping switching reaches a time threshold, the control circuit is configured to enter the sleep mode.

18. The control circuit of claim 16, wherein the sleep mode determining circuit is further configured to determine whether to exit the sleep mode based on the sync signal pulse, wherein in response to the sync signal pulse appearing, the control circuit is configured to exit the sleep mode.

19. The control circuit of claim 16, wherein during a time period when a load is disconnected from the switching converter, in response to an output voltage of the switching converter increasing to a first output threshold, the output feedback circuit is configured to be a cut off connection state.

20. The control circuit of claim 19, wherein during the time period when the load is disconnected from the switching converter, in response to the output voltage decreasing to a second output threshold, the output feedback circuit is configured to be a normal connection state.
